(19) United States
(12) Patent Application Publication
(10) Pub. No.: US 2002/0161720 A1
(43) Pub. Date: Oct. 31, 2002

(54) Data supplying method and a portable terminal unit and a data supplying apparatus used in the method

(75) Inventors: Kenichi Hamazaki, Tokyo (JP); Hiroshi Shimizu, Tokyo (JP); Naoki Mori, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/052,286

(22) Filed: Oct. 19, 2001

(30) Foreign Application Priority Data
Feb. 5, 2001 (JP) 2001-028320

(51) Int. Cl. G06F 17/60

(52) U.S. Cl. 705/64; 705/67; 705/73; 705/77; 340/995

(57) ABSTRACT

An object of the present invention is to provide a data supplying method that can simply arrange photographing data together with supplementary information and a portable terminal unit used in the method and a data supplying apparatus.

The photographing data, such as an image photographed by a portable terminal in a move destination is sent to the data supplying apparatus together with the supplementary information, such as store data and map data. The data supplying apparatus supplies movement trail data created by combining the photographing data and the supplementary information to a terminal on the user side.

### BACKGROUND OF THE INVENTION

1. Technical Field of the Invention

The present invention relates to an apparatus and a method for supplying data using the technology that combines image data or position data acquired by a terminal with map data.

2. Description of the Related Art

As a prior art related to the present invention, Japanese Patent application laid-open No. Hei 9-179491 discloses a technology for displaying an image photographed by a digital camera on a digital map, by associating position data and time data on the trail of a vehicle traveling, and position data and time data of the image taken by the digital camera.

A user frequently arranges a plurality of photographs photographed in his or her leisure time and journey in album as a method for preserving the photographs. When the photographs are stored in the album, there are problems such as expansion of storage sites caused by an increase in the number of albums, and deterioration of photographs due to passage of time. When a user merely stores data photographed by a digital camera in a storage medium in the order in which it was simply photographed, the user will be at a loss because he or she cannot tell the data was photographed under any circumstances even if he or she views the image later. Further, in the technology disclosed in JP-A No. Hei 9-179491, the position data can be acquired only when a user moves by a vehicle. Moreover, in the technology described in JP-A No. Hei 9-179491, since a mobile terminal that acquires the position data and a camera that acquires image data are connected using a cable, movement and photographing work are disturbed.

### SUMMARY OF THE INVENTION

The problems to be solved according to the present invention are as follows:

(1) When image data stored in a storage medium in the order in which it is simply photographed is viewed later, it can immediately be known that the data was photographed under any circumstances,

(2) Position data can be acquired even using the transfer method other than the movement by driving of a car, and

(3) The position data and the image data can be acquired without performing any cable connection.

The present invention has been made in view of the above circumstances and provides a data supplying method and a portable terminal unit and a data supplying apparatus used in the method in which acquisition of the position data is easy and the image data and the position data can easily be associated.

To solve the above problems, according to an aspect of the present invention, the data supplying method receives user data that is sent from a first terminal and contains image data, and position data and time data when the image data is acquired, creates compound data by combining this user data with map data and store data, and sends the compound data to a second terminal on which this compound data can be displayed or the first terminal.

Further, according to another aspect of the present invention, the data supplying method receives user data that is sent from a first terminal and contains image data, and position data and time data when the image data is acquired, receives store data from a first database, creates compound data by combining these user data and store data with map data to create compound data, sends the compound data to a second terminal on which this compound data can be displayed or to the first terminal, and performs at least either charging to the store data supplier or charging to either the first terminal or the second terminal by calculating a rate of the compound data.

According to another aspect of the present invention, the portable terminal unit has an image photographing apparatus, a transmitter that sends the image data photographed by this image photographing apparatus to a service center together with the time data and position data of which photographing was performed, and a display unit of the image data, and when compound data in which the image data, time data, and position data are combined with store data and map data is received from the service center, a pointer based on the store data and a pointer based on the image data are displayed on a map displayed on the display unit.

According to a preferred embodiment, a database that contains the store data can be accessed by selecting the pointer based on the store data.

According to another embodiment, an image photographed at the pointer position is displayed on the display unit by selecting the pointer based on the image data.

According to another aspect of the present invention, the data supplying apparatus has a storage device that stores user data that is sent from a first terminal and contains image data, and position data and time data when the image data is acquired together with map data and store data and a combining unit that creates compound data by combining the user data and the store data with the map data, and the compound data is supplied to the first terminal or the second terminal on which the compound data can be displayed.

Further, according to another aspect of the present invention, the data supplying apparatus has a storage device that stores user data that is sent from a first terminal and contains image data, and position data and time data when the image data is acquired together with map data and store data, a combining unit that creates compound data by combining the user data and the store data with the map data, a supplying apparatus that supplies the compound data to the first terminal or a second terminal on which the compound data can be displayed, and a charging unit that performs charging to a store data supplier or charging to either the first terminal or the second terminal by calculating a rate of the compound data.

According to another aspect of the present invention, it is immediately known that image data was photographed under any circumstances when it is viewed later only if it is stored in a storage medium in the order in which it is simply photographed. Editing of the image data is also easy. Position data can be acquired even if movement is not performed by driving of a car. The position data and the image data can be acquired without performing any cable connection.

### BRIEF DESCRIPTION OF THE DRAWINGS

Preferred embodiments of the present invention will be described in detail based on the followings, wherein:

FIG. 1 shows the entire configuration of a system according to one embodiment of the present invention;

FIG. 2 is a block diagram showing a configuration of a system according to another embodiment of the present invention;

FIG. 3 shows a configuration of a data supplying apparatus according to another embodiment of the present invention;

FIG. 4 shows user data stored in the data supplying apparatus according to another embodiment of the present invention;

FIG. 5 shows store data stored in the data supplying apparatus according to another embodiment of the present invention;

FIG. 6 shows a screen created by the data supplying apparatus according to another embodiment of the present invention;

FIG. 7 shows a processing procedure of the data supplying apparatus according to another embodiment of the present invention;

FIG. 8 shows an image memory of the data supplying apparatus according to another embodiment of the present invention;

FIG. 9 shows an example of data supplied from a server according to another embodiment of the present invention; and

FIG. 10 shows a data processing procedure of the system according to another embodiment of the present invention.

### DETAILED DESCRIPTION OF THE INVENTION

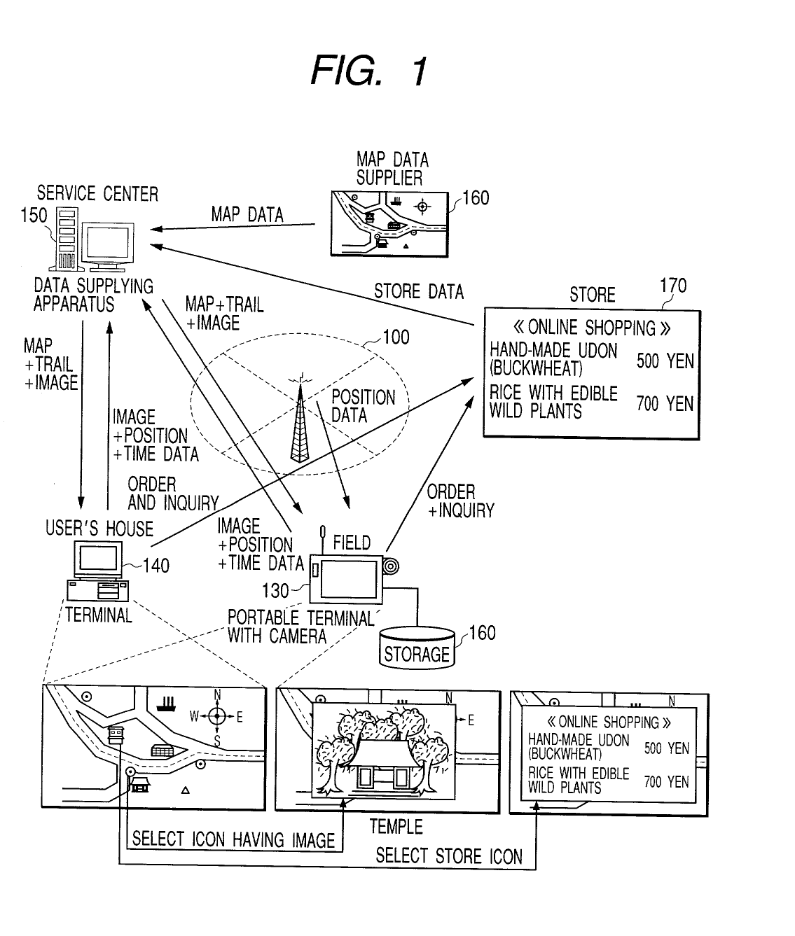

Embodiments of the present invention are described later with reference to FIGS. 1 to 10.

FIG. 1 is an example showing the entire configuration of a system of a data supplying apparatus according to one embodiment of the present invention.

In FIG. 1, 100 is a network, and a first terminal 130 is a portable terminal with a camera. A user can move or travel carrying the terminal. Besides, the camera may also be an accessory that can be attached to or detached from the main body (portable terminal). A storage device 131 stores image data and position data acquired by the portable terminal, and time data indicating time when the image data is acquired. Specifically, the storage device 131 has an optical storage medium, such as an optical disc, or a magnetic storage medium, such as a magnetic disc or a magnetic tape, or an electronic storage medium, such as a semiconductor memory. The storage device 131 is either built-in device in the portable terminal 130 with a camera or a detachable accessory. A storage medium is mounted so as to freely be attached to and detached from a storage device and can also read data by another unit. A numeral 150 is a data supplying apparatus of a service center. A numeral 140 is a terminal provided in a user's house and a second terminal that can receive and display data (compound data) sent from the data supplying apparatus. A numeral 160 is a server of a map data supplier (for example, a geographical information provider). A numeral 170 is a server of a store data supplier. This server stores information about merchandise sold in a store as a first database and can supply this information to the data supplying apparatus 150 as store data. Further, when the information is accessed from the first terminal 130 or the second terminal 140, the server 170 enables online transaction processing, such as online shopping. In this embodiment, when a user photographs an image by the portable terminal 130 with a camera at a site visited during the travel, image data, and position data and time data when the image data is acquired are stored in the storage device 131. The acquired position data is associated with photographed image data and stored in the storage device 131. Thus, a trail on which a user moves or travels in his or her leisure time or journey and the image data associated with the trail are recorded in the storage device 131. Further, the portable terminal 130 sends the acquired image data, position data, and time data to the data supplying apparatus 150 of the service center via the network 100. Moreover, map data is sent from the server 160 of the map data supplier to the data supplying apparatus 150 of the service center through the network 100 and store data, such as store or merchandise data is sent from the server 170 of the store data supplier via the network 100. The data supplying apparatus 150 receives these data and stores them in a storage device respectively. In such state, when a request is made from the portable terminal 130 or the terminal 140, the data supplying apparatus 150 creates compound data by combining image data, position data, time data, and store data with map data by the combining means and sends the compound data to the portable terminal 130 or the terminal 140. Regarding the contents of compound data, in the portable terminal 130 or the terminal 140, an image pointer based on the image data and a store pointer based on the store data are displayed on the map data. When at least either of the pointers is selected, the contents data that corresponds to the selected pointer displayed. FIG. 1 shows a display example when an image pointer (image icon) and a store pointer (store icon) are selected. Based on the display information, an order for the merchandise can be given to the store or an inquiry about the merchandise for the store data supplier can be made. Either the portable terminal 130 or the terminal 140 or another means may also make the order or inquiry.

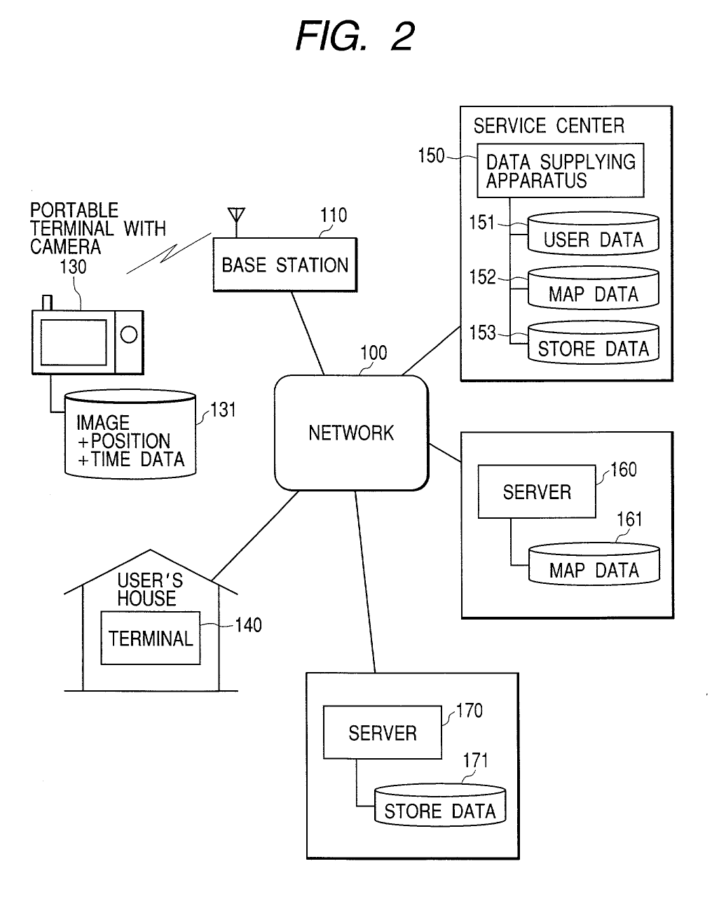

FIG. 2 shows the configuration of FIG. 1 as a block diagram.

In FIG. 2, 110 is a base station that connects the portable terminal 130 with a camera to the network 100 and 151 is a storage device that stores user data in the data supplying apparatus 150 of the service center. A numeral 152 is a storage device that stores map data and 153 is a storage device that stores store data. A numeral 161 is a storage device that stores the map data in the server 160 of the map data supplier and 171 is a storage device that stores the store data in the server 170 of the store data supplier.

The user terminal 140 can request the data supplying apparatus 150 to create and supply compound data in which trail data and image data are edited on map data, to view the supplied compound data, and to be used as the Internet browser.

The data supplying apparatus 150 manages user data sent by a user every user. The data supplying apparatus 150 illustrates a pointer indicating that there are a trail and an image based on the user data, on the map data 152 according to a request from the terminal 140, illustrates a store pointer based on the store data, and sends the compound screen to the terminal 140. For example, when the store pointer is selected on the screen of the terminal 140, it is linked to the server 160 via the network 100 and store information and merchandise information are displayed on the screen of the terminal 140.

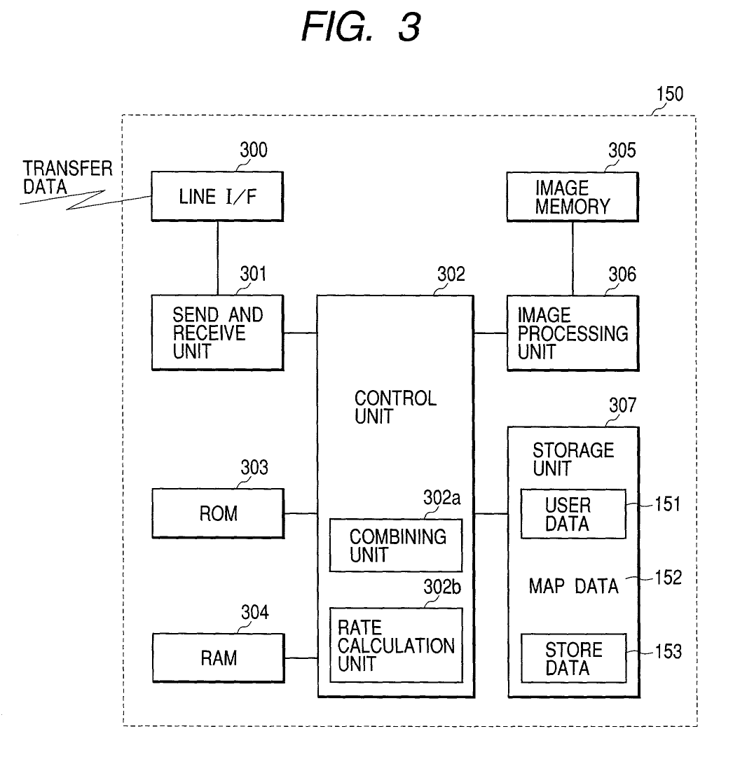

FIG. 3 shows a configuration example of the data supplying apparatus 150 according to one embodiment of the present invention.

In FIG. 3, a numeral 300 is a line I/F (interface) that is connected to the network 100. A send and receive unit 301 converts received packet data to storage data, and packets and sends compound data. A control unit 302 has a combining unit 302a that creates the compound data and a rate calculation unit 302b that calculates a rate and controls the entirety of the data supplying apparatus. A RAM 303 temporarily stores a program and data. A ROM 304 stores the program. An image memory 305 temporarily stores image data until the compound data to be supplied is created. An image processing unit 306 compresses and expands the image data. A storage unit 307 stores user data, map data, and store data. The image data, position data, and time data from the portable terminal 130 with a camera are received by the send and receive unit 301 via the line I/F 300 and stored in the storage device 151 of the storage unit 307 as the user data. When a request for the supply of compound data from the terminal 130 or 140 on the user side is made, the control unit 302 selects the map data that corresponds to desired position data from among the stored map data and creates compound data using the combining unit 302a by combining the selected map data, user data, and store data. The created compound data is sent to the terminal 130 or 140 on the user side via the send and receive unit 301 and the line I/F 300.

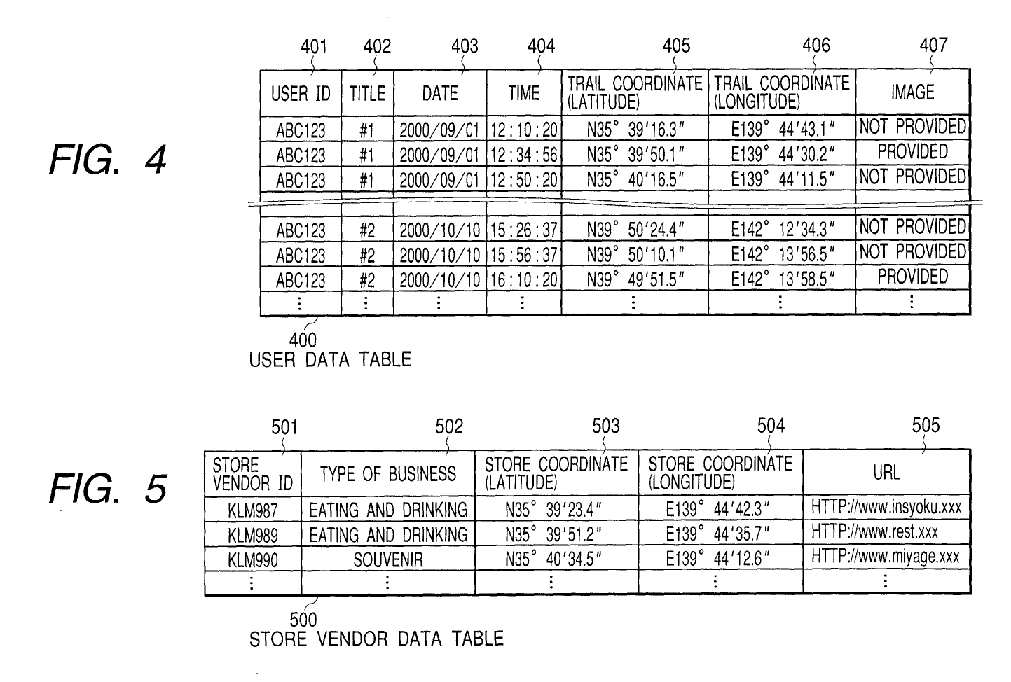

FIG. 4 shows an example of a table stored in the data supplying apparatus 150 as user data. In a user data table 400, 401 is a previously registered user-unique user ID and 402 is a title a user sets for every leisure activity or journey. The data supplying apparatus 150 sets the initial value. A numeral 403 is a date when image data and position data are recorded and 404 is an hour when the image data and the position data are recorded. A numeral 405 is latitude of the position data and 406 is longitude of the position data. A numeral 407 is a flag for determining the presence of image data.

FIG. 5 shows an example of a table stored in the data supplying apparatus 150 as store data. In a store data table 500, a numeral 501 is a previously registered store-unique user ID, 502 is a type of business of a store, 503 is the latitude of the store, 504 is the longitude of the store, and 505 is a URL (uniform resource locator) on the home page of the store.

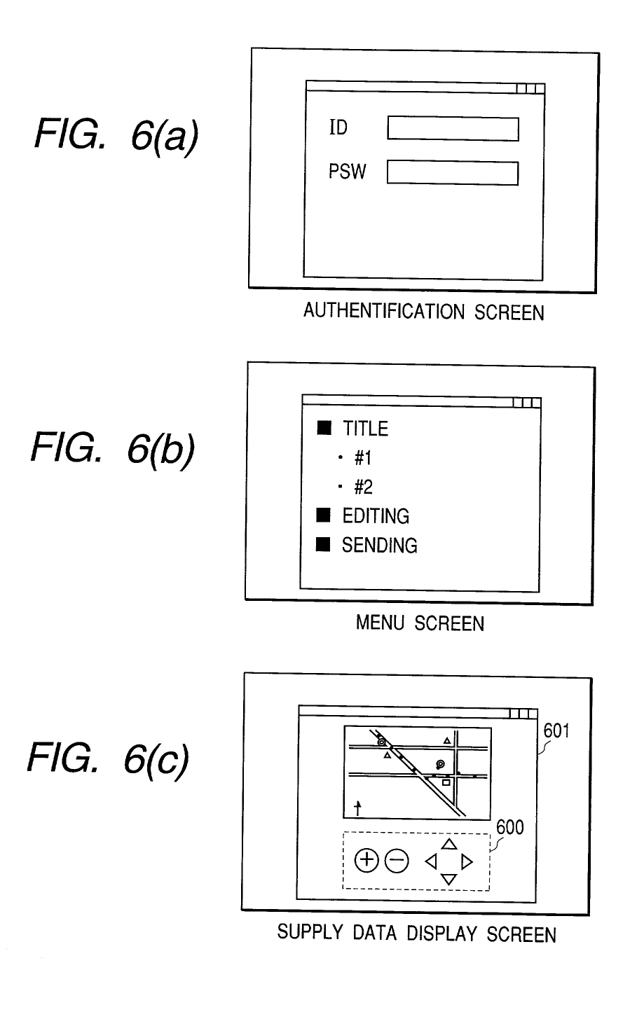

FIG. 6 shows an example of the screen that is created by the data supplying apparatus 150 and supplied to the user terminal 130 or 140.

When the user portable terminal 130 or the terminal 140 is connected to the data supplying apparatus 150 via the network 100, as shown in FIG. 6(a), the data supplying apparatus 150 sends an authentication screen to which a previously created ID and password for user authentication are input and displays it on the screen of the portable terminal 130 or the terminal 140. The person himself or herself is authenticated by the input from this screen, thereby preventing invalid use. The control unit 302 of the data supplying apparatus 150 that performed the authentication of data input in FIG. 6(a) sends FIG. 6(b) that is the menu screen to the user portable terminal 130 or terminal 140 and displays it on the screen. A title the control unit 302 displays matches a user ID input in FIG. 6(a) in the user data table 400 stored in user data. FIG. 6(b) contains a menu for performing sending, such as title editing and image selection. When a title from which data is to be supplied is selected in the user terminal 130 or 140 that displays FIG. 6(b), the data supplying apparatus 150 creates a supply data display screen having an operation button 600 as shown in FIG. 6(c) and sends and displays it to and on the portable terminal 130 or the terminal 140.

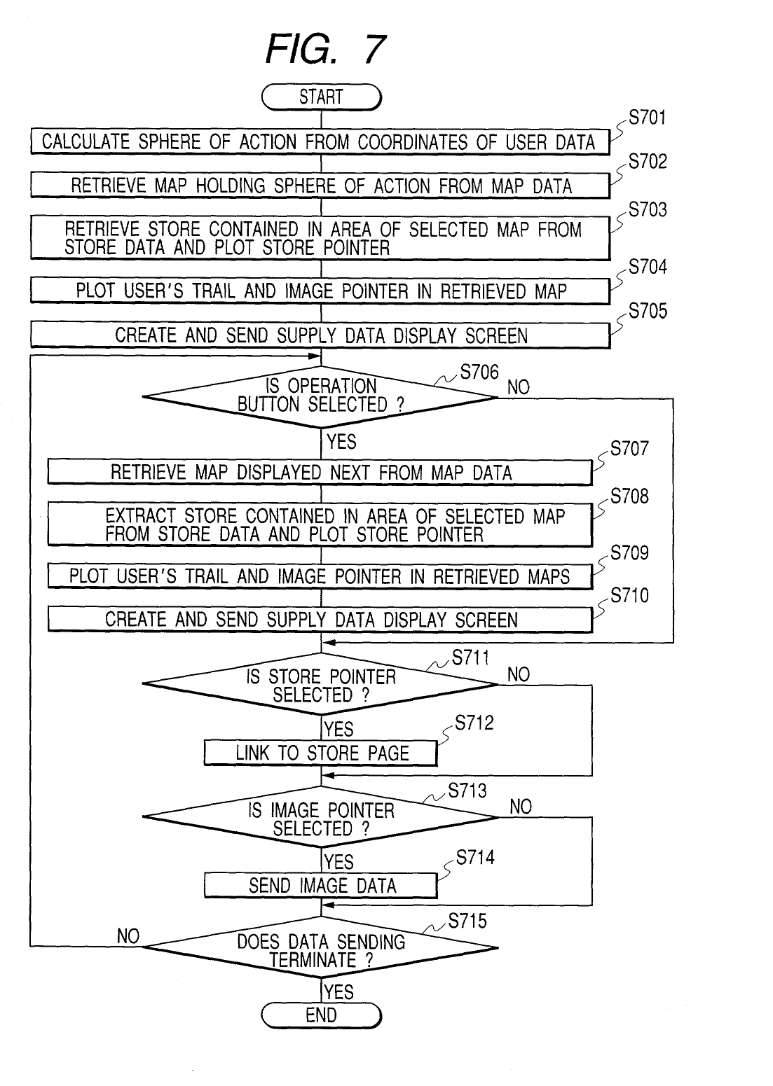

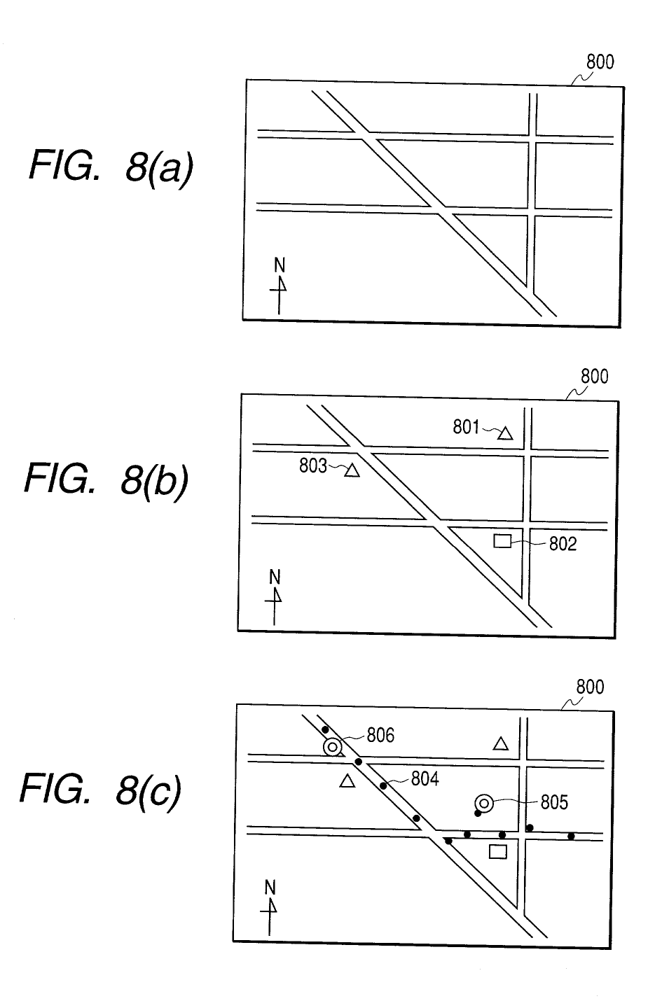

FIGS. 7, 8, and 9 are an explanatory drawing of the processing in the data supplying apparatus 150 when any title is selected if the display as shown in FIG. 6(b) is made on the screen of the user terminal 130 or 140. When data indicating that the title was selected is received, the control unit 302 of the data supplying apparatus 150 calculates the maximum latitude and longitude and the minimum latitude and longitude from the trail coordinate (latitude) 405 and the trail coordinate (longitude) 406 of a record that matches a title selected from the title 402 of the user data table 400 and determines a user's sphere of action (S701). Subsequently, a map of which sphere of action is covered is selected from the map data 152 (S702). FIG. 8(a) shows a selected map 800. Then a store included in the range of the map 800 is retrieved based on the store coordinate (latitude) 503 and the store coordinate (longitude) 504 of the store data table 500, and the combining unit 302a plots the store within the sphere of action using a pointer of a different display mode as shown in FIG. 8(b) so that the store can be determined per type of business (S703). FIG. 8(b) shows that a pointer 801 and a pointer 803 are of the same business type and a pointer 802 is of a different business type. Subsequently, coordinates of a record of a title specified from the user data table 400 are plotted in the map 800 as a trail 804. Further, when the image 407 in the record is “Provided”, the pointers (image pointers 805 and 806) indicating there is an image photographed at the positions 805 and 806 are plotted (S704). The combining unit 302a of the control unit 302 combines map and pointer images by controlling the image processing unit 306 and the image memory 305. Further, the combining unit 302a creates a supply data display screen 601 on which the map 800 and the operation button 600 are arranged (S705). Besides, the store pointers 801, 802, and 803 and the image pointers 805 and 806 can be selected on the terminal 130 or 140.

In the supply data display screen 601 displayed on the user terminal 130 or 140, when the operation button 600 is selected (S706), the control unit 302 determines that any one of enlargement, reduction, the top and bottom, and the left and right are selected and selects a map displayed subsequently (S707). Then in the same manner as the above step S703, the combining unit 302a plots a pointer of a store included within an area of a selected map (S708). Subsequently, in the same manner as the step S704, when a user's trail and image are provided, the image pointer is plotted (S709) and the supply data display screen 601 is re-created and sent (S710), then is displayed on the user terminal 130 or 140. In the supply data display screen 601 displayed on the terminal 130 or 140, when the store pointer (any one of 801, 802, and 803) is selected (S711), the store pointer is set to link to the URL 505 provided in store data, and the user terminal 130 or 140 is connected to the server 160 via the network 100 and can access the store data that stores the store contents.

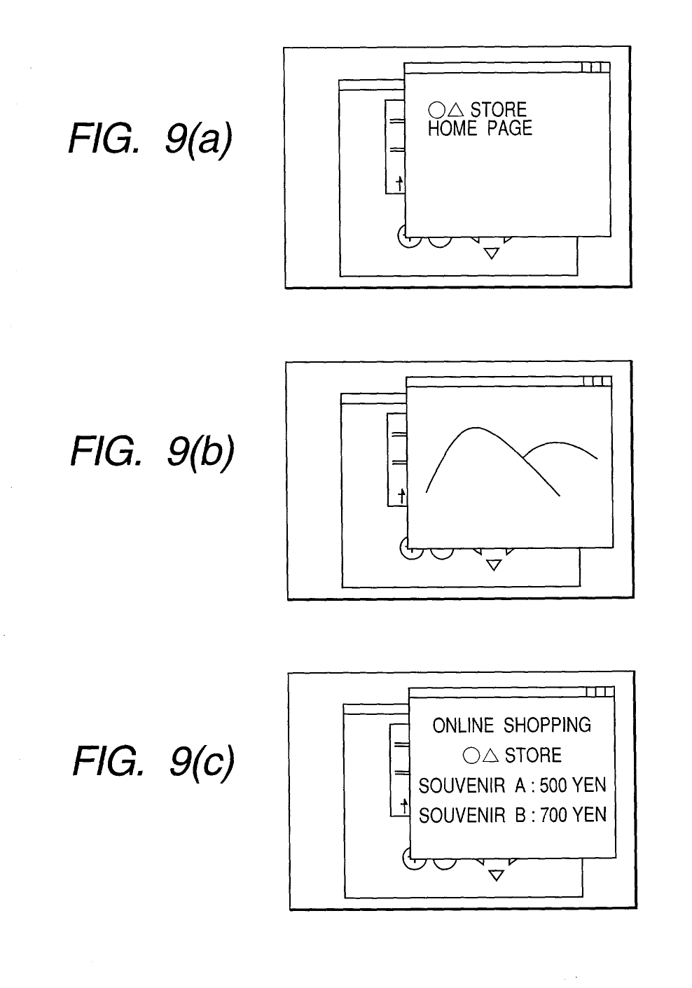

For example, as shown in FIG. 9(a), a home page of a store is displayed on the terminal 130 or 140 (S712). In the supply data display screen 601 displayed on the terminal 130 or 140, when the image pointer (either 805 or 806) is selected (S713), for example, as shown in FIG. 9(b), an image photographed at that point is displayed (S714). In the processing procedure, the processing procedures of both S703 and S704 and both S708 and S709 may also be replaced. Further, another receiving means as well as the user terminal 130 or 140 can be used to receive the data supplied from a data supplying apparatus. When the data is received by the portable terminal 130, the compound data from the data supplying apparatus 150 can be viewed even in a move destination.

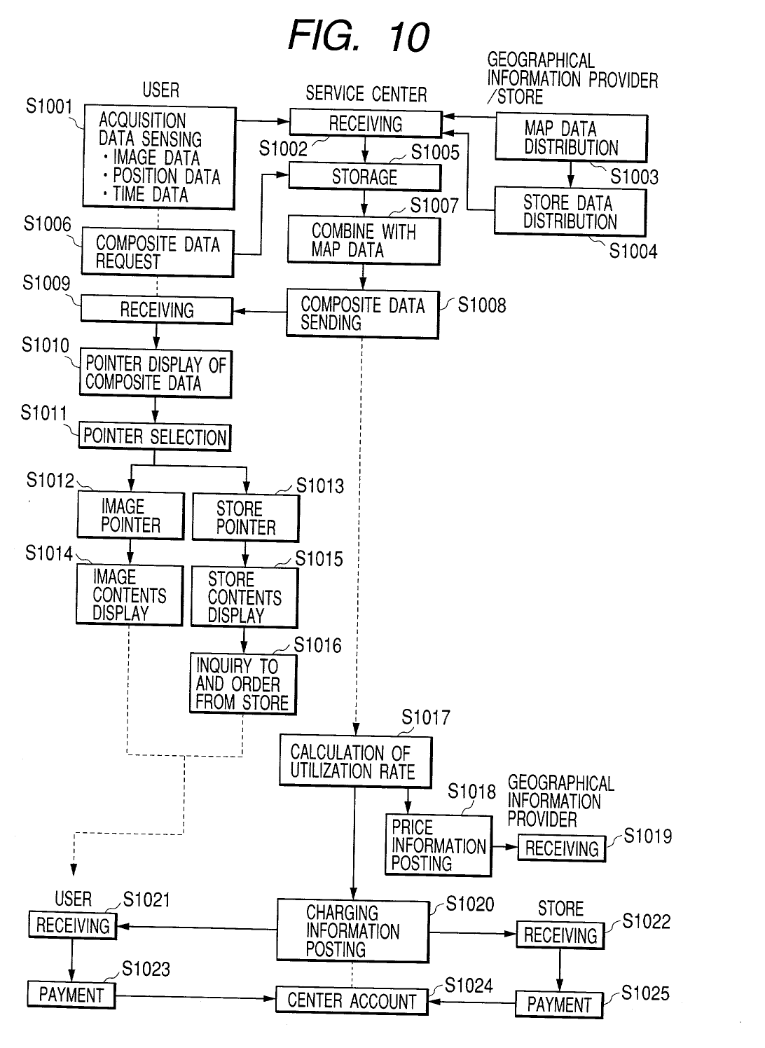

FIG. 10 shows an example of the data sending and receiving among the terminal 130 or 140 on the user side, the data supplying apparatus 150 of a service center, a map data supplier (geographical information provider), and a store, the operation in the terminal 130 or 140 on the user side, and the charging procedure in the terminal 130 or 140 on the user side.

In FIG. 10, the processing procedure is as follows:

(1) The image data, position data, and time data acquired from the portable terminal 130 with a user's camera are sent to a service center as user data (S1001). Map data is distributed from a geographical information provider and store data is distributed from a store to the service center respectively.

(2) The data supplying apparatus 150 of the service center receives these data (S1002) and stores them in a storage unit (S1003).

(3) A request of compound data is made from the portable terminal 130 with a user camera or the terminal 140 of a user's house (S1006).

(4) The data supplying apparatus 150 retrieves and selects appropriate map data from stored map data and creates compound data by combining the selected map data, user data, and store data (S1007). The combined data is sent to the terminal 130 or 140 on the user side to which a request was made (S1008).

(5) The terminal 130 or 140 on the user side receives this data (S1009) and the compound data is pointer-displayed on the screen (S1010).

(6) Further, an image pointer and a store pointer are selected on the screen (S1011). When the image pointer is selected (S1012), the image contents that correspond to it are displayed (S1014). When the store pointer is selected (S1013), the store contents that correspond to it are displayed (S1015). After the store contents are displayed, an inquiry or an order (online shopping) is made from the terminal 130 or 140 to a store is made as occasions demand (S1016). The inquiry and order may also be made for the service center.

(7) When the data supplying apparatus 150 of the service center completes a series of sending and receiving with the terminal 130 or 140 on the user side, a utilization rate is calculated (S1017) and a charge, such as data combining and supply to the terminal 130 or 140 on the user side, is sent as charging information (S1020), then a utilization rate of map data is posted to a terminal of a map data provider as charging information (S1018). The distribution rate of store data to the user side is also posted to a terminal on the store side as the charging information (S1020). The distribution of store data to the user side is positioned as advertisement and the distribution rate is specified as a discount point on the user side. Then the amount payable on the user side may also be reduced.

(8) After a user or store receives and checks each of the charging information, a rate is paid to an account of a service center. The service center also pays a utilization charge for map data to a map provider.

As described above, according to this embodiment, a user records a trail where he or she passed along in his or her leisure time or journey. Further, since a photographed image is recorded in the state related to the trail, the rearrangement of the image is facilitated. Further, since store information is issued on a map, detailed information about a store where the user dropped during his or her leisure activity or journey can be known later and local products can be purchased later. Further, the service center can charge the user for managing a user's trail and image data, and can also charge the store for issuing store information on a map. Further, the store can advertise the store and products involved in the geographical information by having the store information issued on the map and can increase sales and profits.

In the embodiment, an inquiry to or an order from the store can directly be made from a user terminal to the store. The present invention is not limited to this. The inquiry or order may also be made from the user terminal to a service center or via the service center. Further, the user data may also be sent from a move destination to the service center and from a terminal of a private house. In the embodiment, the store tried to distribute store data into the service center. Additionally, a store information provider becomes a distributor of the store data and may also distribute the store data to the service center. In this case, the store information provider may also accept a user's inquiry and order and a liaison of charging information from the service center. The store can use the method of the present invention for mail-order sales and online shopping.

What is claimed is:

1. A data supplying method, comprising the steps of:
receiving user data that is sent from a first terminal and contains image data, and position data and time data when the image data is acquired;
creating compound data by combining this user data with map data and store data; and
sending the compound data to a second terminal on which this compound data can be displayed or the first terminal.

2. A data supplying method, comprising the steps of:
receiving user data that is sent from a first terminal and contains image data, and position data and time data when the image data is acquired;
receiving store data from a first database;
creating compound data by combining these user data and store data with map data;
sending the compound data to a second terminal on which this compound data can be displayed or the first terminal; and
calculating a rate of the compound data to carry out at least either of charging to a distributor of the store data or charging to either the first terminal or the second terminal.

3. The data supplying method according to claim 2, wherein the first terminal or the second terminal can access the first database when the compound data is received.

4. A portable terminal unit, comprising:
an image photographing unit;
a transmitter that sends image data photographed by this image photographing unit to a service center together with time and position data for which photographing is performed; and
a display unit of the image data,
wherein a pointer based on store data and a pointer based on the image data are displayed on a map displayed on the display unit when compound data in which the image data, time data, and position data are combined with the store data and map data are received from the service center.

5. The portable terminal unit according to claim 4, wherein a database containing the store data can be accessed by selecting the pointer based on the store data.

6. The portable terminal unit according to claim 4, wherein an image photographed at the pointer position is displayed on the display unit by selecting the pointer based on the image data.

7. A data supplying apparatus, comprising a means that stores store data,
wherein the stored store data can be supplied to a combining unit that creates compound data by combining image data, position data, time data, the store data, and map data.

8. A data supplying method, in which data is supplied via the steps of:
receiving image data as user data sent from a movable first terminal, position data and time data when the image data is acquired, map data, and store data;
storing the data;
creating compound data by combining the user data and store data with the map data; and
supplying the compound data to the first terminal or a second terminal side on which the compound data can be displayed.

9. A data supplying method, in which data is supplied via the steps of:
receiving image data as user data sent from a movable first terminal, position data and time data when the image data is acquired, map data, and store data;
storing the data;
creating compound data by combining the user data and store data with the map data;
supplying the compound data to the first terminal or a second terminal side on which the compound data can be displayed; and
calculating a rate of the combining and supply to carry out charging to the store data distributor, the first terminal side or the second terminal side.

10. The data supplying method according to claim 9, wherein, in the step of charging, an amount of charging to the store data distributor is specified as a discount point and an amount of charging to the first terminal side or the second terminal side is calculated.

11. A data supplying apparatus, comprising:
a storage device that stores user data which is sent from a first terminal and contains image data, and position data and time data when the image data is acquired together with map data and store data; and
a combining unit that creates compound data by combining the user data and the store data with the map data, wherein the compound data is supplied to the first terminal or a second terminal on which the compound data can be displayed.

12. A data supplying apparatus, comprising:
a storage device that stores user data which is sent from a first terminal and contains image data, and position data and time data when the image data is acquired together with map data and store data;
a combining unit that creates compound data by combining the user data and the store data with the map data;
a supplying apparatus that supplies the compound data to the first terminal or a second terminal on which the compound data can be displayed; and
a charging unit that calculates a rate of the compound data and performs charging to a store data distributor or performs charging to either the first terminal or the second terminal.

13. The data supplying apparatus according to claim 11 or 12, wherein the combining unit, in the first terminal or the second terminal, displays an image pointer based on image data and a store pointer based on store data on the map data and the data that corresponds to the selected pointer is displayed when at least either of the pointers is selected.

14. The data supplying apparatus claim 11 or 12, wherein the storage device stores the user data in accordance with a user ID.

15. The data supplying apparatus according to claim 11 or 12, wherein the combining unit retrieves map data used in combining from the user data.

16. A data supplying apparatus, comprising:
a storage device that stores map data,
wherein the stored map data can be supplied to a combining unit for creating compound data by combining the map data, image data, position data, time data, and store data.
